(19) United States
(12) Patent Application Publication
(10) Pub. No.: US 2006/0093180 A1
(43) Pub. Date: May 4, 2006

(54) Magnetic circuit having dual magnets, speaker and vibration generating apparatus using the same

(76) Inventor: Seong Bae Kim, Seoul (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/251,816

(22) Filed: Oct. 18, 2005

(30) Foreign Application Priority Data
Oct. 18, 2004 (KR) 10-2004-83019

(51) Int. Cl. H04R 9/06

(52) U.S. Cl. 381/412

(57) ABSTRACT

A magnetic circuit having a dual magnet, a speaker and a vibration generating apparatus using the same are provided. The magnetic circuit includes a magnetic gap having a small magnetic loss and an increasing magnetic flux density, in which a uniform distribution of a line of magnetic force can be realized on yoke surfaces facing each other. The speaker includes lower and upper magnets which are spaced so that mutually identical polarities oppose each other; a first yoke integrally having a loop-type circulating circuit portion extended from the lower magnet to the upper magnet and an extension portion which is extended perpendicularly upwards from the lower magnet; a second yoke which connects between the lower and upper magnets and forms a magnetic gap between the second yoke and the extension portion of the first yoke; a coil disposed in the magnetic gap and wound around a bobbin; a frame which is extended from the first yoke; a vibrating diaphragm generating an acoustic sound in correspondence to a drive signal; a damper limiting a vibration range of the bobbin; and a center cap covering the bobbin.

### BACKGROUND OR THE INVENTION

1. Field of the Invention

The present invention relates to a magnetic circuit having a dual magnet, a speaker and a vibration generating apparatus using the same, and more particularly, to a magnetic circuit having a dual magnet, a speaker and a vibration generating apparatus using the same, in which a P-type magnet and a F-type magnet are included in a dual magnetic circuit, having a small magnetic loss and an increasing magnetic flux density, in a magnetic gap to thereby realize a uniform distribution of a line of magnetic force on yoke surfaces facing each other and forming the magnetic gap, and to thus have characteristics of high efficiency, high output, and low distortion frequency.

2. Description of the Related Art

In general, acoustic reproduction devices are classified into a horn speaker, a system speaker which is used for a hi-fi audio system such as a component system, having a woofer, a midrange and a tweeter covering a certain frequency band, a general speaker covering the whole frequency band with a single unit, a microspeaker having an ultra-weight and ultra-slim structure which is used in small-sized electronic equipment such as an ultra-micro camera recorder called a camcorder and a walkman™, a receiver which is used for a mobile communication terminal, and an earphone whose part is inserted into the ear, and a buzzer reproducing only frequency of a particular band.

Referring to FIGS. 1A and 1B, in the case of a conventional general speaker, a single magnet 1 is installed in the outer or inner portion of a yoke 2. A bobbin 5 around which voice coil 4 is wound is located in a magnetic gap G formed in the magnetic circuit M where a top plate 3 is installed on the magnet 1. Also, the upper portion of the bobbin 5 is fixed to both a vibrating diaphragm 7 whose outer circumference is fixed to the upper portion of a frame 6 and whose center portion is circularly perforated and a damper 8 whose outer circumference is fixed to the lower portion of the frame 6. Also, a center cap 9 called a dust cap for covering the hole of the bobbin 5 is coupled with the center of the vibrating diaphragm 7.

In the above-described speaker, a non-alternating (DC; Direct Current) magnetic flux generated in the fixed magnetic circuit M and an alternating (AC; Alternating Current) rotating magnetic flux react with each other according to the Fleming's left-hand rule, and the vibrating diaphragm 7 and a voice coil 4 are vibrated up and down by attraction and repulsive forces generated by the reacted non-alternating magnetic and magnetic fluxes, to thereby generate a sound corresponding a driving signal.

In the case of the magnetic circuit M where the magnetic gap G is formed between the center pole of the yoke 2 and the top plate 3, using the conventional single magnet 1, the opposing yoke surfaces that form the magnetic gap G are relatively limited and small in magnitude, and a uniform magnetic flux density is not formed on the opposing yoke surfaces.

That is, a portion on the opposing yoke surface that is relatively close from the magnet 1 has a high magnetic flux density in comparison with a portion on the opposing yoke surface that is relatively far from the magnet 1. As a result, the attractive and repulsive forces applied to the voice coil 4 which is inserted into the magnetic gap G between the opposing yoke surfaces cause non-uniformity according to the position of the voice coil 4.

This phenomenon influences upon the up-and-down vibration of the bobbin 5 around which the voice coil 4 is wound when an original sound signal is reproduced, and thus causes distortion during reproduction of the original sound signal in the vibrating diaphragm 7.

In order to solve the above-described problems, a magnetic circuit for a speaker forming uniform magnetic flux distribution has been proposed in the Korean Laid-open Patent Publication No. 2004-82462. In the Korean Laid-open Patent Publication 2004-82462, a number of pole pieces having respectively different permeability are stacked over one another, or a space portion is formed between two pole pieces to thereby increase the number of edges on which the lines of the magnetic force are concentrated and make distribution of the lines of the magnetic force uniform. Accordingly, straightforwardness of the voice coil has been improved.

However, the technical method disclosed in the Korean Laid-open Patent Publication 2004-82462 provides an effect of improving straightforwardness of the voice coil, but does not prevent a magnetic flux leakage phenomenon to be described later and lowering of an efficiency, and does not propose the whole countermeasure for a large allowance input for a high output and a scheme of increasing a magnetic flux density.

That is, in the conventional speaker magnetic circuit M shown in FIGS. 1A and 1B, a number of lines of leakage magnetic force that do not pass through the magnetic gap G do not have an influence upon a reciprocal action with the voice coil 4, but have a bad influence upon peripheral devices such as television sets installed nearby.

One of the conventional structures of solving the leakage magnetic flux problems has been disclosed in the Korean Utility-model Publication No. 1990-11300. Similarly to the P-type speaker, a speaker having a structure for shielding a divergence of a magnetic field disclosed in the Korean Utility-model Publication No. 1990-11300 forms a magnetic circuit in which upper yokes are connected via a cover supporting a magnet, to thereby make a magnetic flux advance from pole pieces to an S-pole via the upper yoke and the cover. However, the magnetic circuit does not accomplish uniform magnetic flux distribution in the structure of the yoke opposing surfaces forming a magnetic gap portion, and thus does not solve straightforwardness of the voice coil.

Also, the magnetic circuit disclosed in the Korean Utility-model Publication No. 1990-11300 employs a leakage magnetic flux prevention structure, in which a pair of annular magnets having an identical polarity are installed at the upper and lower portions of the yoke in opposition to each other and thus leakage of the magnetic flux is prevented by a repulsive force between the identical polarities in the annular magnets. However, it is difficult to compulsively mount the magnets of the identical polarity, and a dual magnet installed in the magnetic circuit does not increase a magnetic flux density in the magnetic gap but decreases performance of the magnets.

Meanwhile, diameter and the number of turns of coil is increased in order to accept a large allowance input for a high output. In order to drive the coil, size of the magnet is increased so that a magnetic flux density in the magnetic gap is increased, or a material having a large magnetic flux density such as Neodymium (Nd) can be used as a magnet material other than a general ferrite material.

In this case, a technology of making a speaker compact and light in view of the speaker enhancing a magnetic force by a double magnet and having an identical magnetic force is disclosed in the Korean Laid-open Patent Publication No. 2000-40796. The Korean Laid-open Patent Publication No. 2000-40796 discloses a speaker having a F-type magnetic circuit in which an annular auxiliary magnet is reversely inserted in the outer circumference of pole pieces. Accordingly, the whole size of the speaker is not increased but the size of the magnet is substantially increased. However, this does not provide a sufficient magnetic flux density appropriate for a high output speaker.

Also, in the case of using a large-scale annular magnet using Neodymium (Nd), it is difficult to assemble other components because of a strong magnetic force thereof. Accordingly, in the same manner as that of a ferrite magnet in most cases, components are in advance assembled, and then the large-scale annular magnet is magnetized using an expansive magnetization facility.

Further, in the case of a sub-woofer having a large-output, large-diameter vibrating diaphragm, a structure of accurately adjusting vertical movement in a vibration system when a base band frequency signal is reproduced is not presented. Accordingly, a frequency reproduction feature goes bad or the vibrating diaphragm may be damaged. Also, heat generated from the voice coil and the magnet is not properly cooled, the feature of the sub-woofer deteriorates.

As described above, the conventional speaker magnetic circuit does not solve leakage of the magnetic flux, non-uniform distribution of the magnetic flux in the magnetic gap, and problems of a high efficiency, high output/high input and heat radiation.

Meanwhile, a vertical exercise device has been proposed as exercise equipment that helps an aerobic exercise and does not have a bad influence upon a joint of the knee. A vibrator in a known conventional vertical exercise device adopts a system using a rotating motor. The rotational vertical exercise device applies vibration to only the abdominal region according to a proper set of an operational frequency to help a user perform an aerobic exercise conveniently. As a result, such a vertical exercise device is medically used for patients of abdominal fatness.

By the way, since the conventional vertical exercise device has an eccentric weight on the rotational axis of the rotating motor, and thus a support plate is vibrated up and down when the eccentric weight is rotated, partial wear of bearings becomes severe due to the eccentricity, and noise is greatly generated.

Also, since the conventional vertical exercise device uses a rotating motor, it is difficult to provide a sufficient vibration force.

Meanwhile, a conventional vibrator for generating vibration in correspondence to audio signals using a magnetic circuit of a speaker using a magnet has been proposed. However, it is appropriate for users to feel three-dimensional vibration in correspondence to audio signals but a magnetic force for driving a vibrating diaphragm lacks for an aerobic exercise. That is, since a magnetic force of a direct-current (DC) magnetic field using permanent magnets does not exceed 5000 Gauss at maximum in an ordinary limited magnitude, such a vibrator is not proper for a vibrating diaphragm driving mechanism for an aerobic exercise.

### SUMMARY OF THE INVENTION

To solve the above problems, it is an object of the present invention to provide a magnetic circuit having a dual magnet of high-efficiency and low-distortion frequency characteristics and a speaker using the same, which includes first and second magnetic circuits respectively including a F-type magnet and a P-type magnet, to thereby improve a linear response of a vibration system, that is, straightforwardness of a voice coil by realization of uniform distribution of lines of magnetic force on opposing surfaces of a yoke forming the magnetic gap in the first magnetic circuit including the F-type magnet, and prevent leakage of a magnetic flux in a magnetic gap portion by a loop-shaped second magnetic circuit including the P-type magnet.

It is another object of the present invention to provide a magnetic circuit having a dual magnet of high-output and high-efficiency characteristics and a radial magnetic field type speaker using the same, in which the magnetic circuit uses a Neodymium (Nd) magnet as a F-type magnet and a P-type magnet, to thereby increase a magnetic flux density in a magnetic gap, and suppress leakage of magnetic flux from occurring from a magnetic gap in a loop-shaped second magnetic circuit.

It is still another object of the present invention to provide a magnetic circuit having a high-output and a speaker using the same, having an enhanced sound pressure level (SPL) of speaker in which a magnetic flux density in a magnetic gap is increased by a dual magnet, an opposing portion between two yokes forming a magnetic gap is relatively lengthily extended in comparison with the conventional art, a number of turns of voice coil inserted into the magnetic gap is sufficiently increased in order to increase an allowance input, to thereby generate a sufficient vibration according to an input signal without limitation of a vibration system and increase size of the magnet.

It is yet another object of the present invention to provide a high-output, low-frequency reproduction speaker having a vertical guide which can precisely help a bobbin perform a vertical movement in a bass band.

It is still yet another object of the present invention to provide a speaker having an enhanced bass characteristic in which a mass of a vibration system is increased by a bobbin, a voice coil and a vertical guide to thereby lower a bass resonance frequency (f₀).

It is a still yet another object of the present invention to provide a magnetic circuit for a speaker in which a number of previously magnetized divided magnets are used to enable direct magnetization to accordingly heighten an efficiency of a magnet and use an inexpensive magnetization facility, in comparison with a conventional indirect magnetization method of assembling and then magnetizing magnets.

It is a further object of the present invention to provide a speaker structure employing a heat-sink structure which can effectively radiate much heat generated in the case that an allowance input applied to a voice coil is large in a high-output speaker.

It is a still further object of the present invention to provide a vibration generation device having low noise and a small amount of wear such as eccentric wear in components in which a bobbin coil connected with a vibrating diaphragm is disposed in a magnetic gap in a magnetic circuit using a double Neodymium (Nd) magnet which generates a strong magnetic force, and the vibrating diaphragm is supported to perform an accurate vertical exercise using a vertical guide.

To accomplish the above object of the present invention, according to an aspect of the present invention, there is provided a speaker having a dual magnet comprising: lower and upper magnets which are disposed at a predetermined distance so that mutually identical polarities oppose each other, for generating a non-alternating magnetic field; a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet; a second yoke which connects between the lower and upper magnets and whose inner circumferential surface forms a magnetic gap between the second yoke and the extension portion of the first yoke; a coil which generates an alternating magnetic filed when an electrical driving signal is applied, and which is disposed in the magnetic gap and wound around a bobbin so as to be displaced up and down according to a mutual action with the non-alternating magnetic field; a frame which is extended in a radial manner from the upper surface of the first yoke; a vibrating diaphragm for generating an acoustic signal in correspondence to a drive signal when one end of the vibrating diaphragm is fixed to the bobbin and the other end thereof is fixed to the upper end of the frame and the coil is displaced up and down; a damper for limiting a vibration range of the bobbin so that the bobbin vibrates within a predetermined vibration range; and a center cap provided at the central portion of the vibrating diaphragm, while covering the bobbin.

In this case, the lower magnet, the extension portion of the first yoke and the second yoke form a first magnetic circuit, and the lower magnet, the loop-shaped circulation circuit of the first yoke, the upper magnet and the second yoke form a second magnetic circuit. Also, the second yoke forms a symmetrical structure and a structure of being branched off toward the lower surface of the upper magnet and the upper surface of the lower magnet from the inner circumferential surface forming the magnetic gap.

The speaker comprises a vertical guide that guides the bobbin to perform vertical movement, in which the vertical guide comprises a cylindrical guide bearing supported vertically in the inner-center of the extension portion of the first yoke; and a guide shaft whose upper side is supported with the upper-center of the bobbin and whose lower sider free end is inserted into the guide bearing.

Further, the speaker according to the present invention further comprises a radiation unit which is inserted between the extension portion of the first yoke and the guide bearing, for discharging heat generated from the coil and the magnets.

In this case, the lower and upper magnets are disposed so that N poles oppose each other, respectively, and are formed of a number of divided discs made of Neodymium (Nd), which are advantageous in view of a high output and assembly.

The opposing surfaces between the outer circumferential surface of the extension portion of the first yoke and inner circumferential surface of the second yoke which form the magnetic gap have uniform distribution of lines of magnetic force in whole, to thereby improve straightforwardness of the voice coil.

According to another aspect of the present invention, there is provided a magnetic circuit having a dual magnet, comprising: lower and upper magnets which are disposed at a predetermined distance so that N poles oppose each other, for generating a non-alternating magnetic field; a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet; and a second yoke which connects between the lower and upper magnets and whose inner circumferential surface forms a magnetic gap between the second yoke and the extension portion of the first yoke, wherein the opposing surfaces between the outer circumferential surface of the extension portion of the first yoke and the inner circumferential surface of the second yoke which form the magnetic gap have uniform distribution of lines of magnetic force in whole.

According to still another aspect of the present invention, there is provided a vibration generating device comprising: lower and upper magnets which are disposed at a predetermined distance so that N poles oppose each other, for generating a non-alternating magnetic field; a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet; a second yoke which connects between the lower and upper magnets and whose inner circumferential surface forms a magnetic gap between the second yoke and the extension portion of the first yoke; a driving coil which generates an alternating magnetic filed when an electrical driving signal is applied, and which is disposed in the magnetic gap and wound around a bobbin so as to be displaced up and down according to a mutual action with the non-alternating magnetic field; a cylindrical bobbin in which the driving coil is wound around a cylindrical body; a vibrating diaphragm which is coupled with the upper end of the bobbin, performing an up-and-down vibration; and a vertical guide unit for guiding the bobbin to perform vertical movement when the vibrating diaphragm is vibrated up and down.

### BRIEF DESCRIPTION OR THE DRAWINGS

The above and other objects and advantages of the present invention will become more apparent by describing the preferred embodiments thereof in detail with reference to the accompanying drawings in which:

FIG. 1A is a cross-sectional view showing the whole structure of a general F-type speaker;

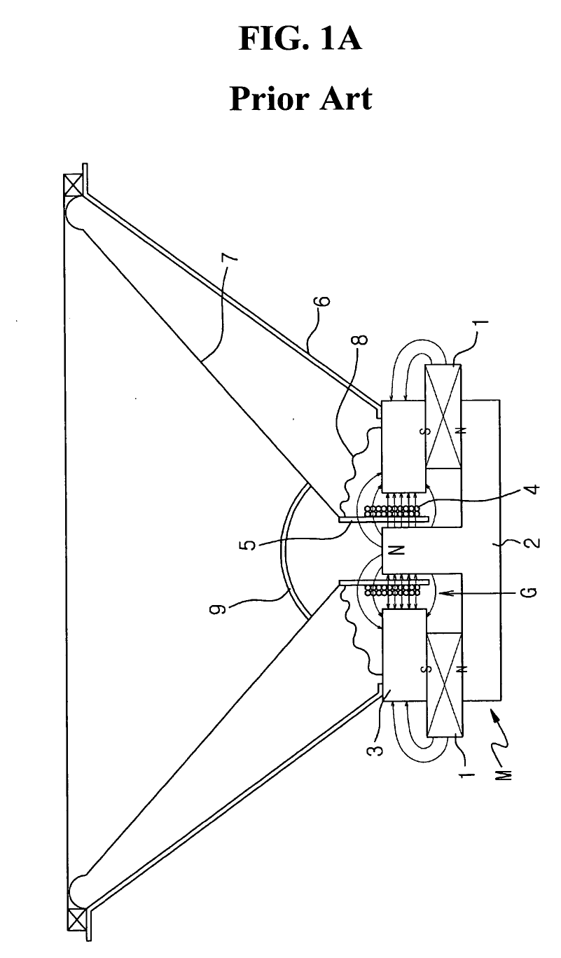

FIG. 1B is a cross-sectional view showing a magnetic circuit of a general P-type speaker;

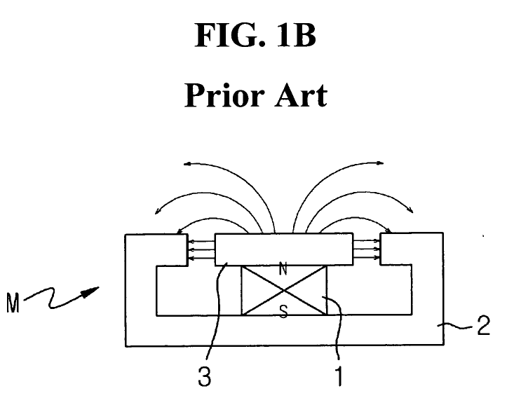

FIG. 2 is a cross-sectional view showing a high-efficiency, high output speaker having a dual magnet according to the present invention; and

FIG. 3 is a cross-sectional view cut along a line X-X of FIG. 2.

### DETAILED DESCRIPTION OR THE INVENTION

Hereinbelow, a magnetic circuit and a speaker using the same according to a preferred embodiment of the present invention will be described with reference to the accompanying drawings. Like reference numerals denote like elements through the following embodiments.

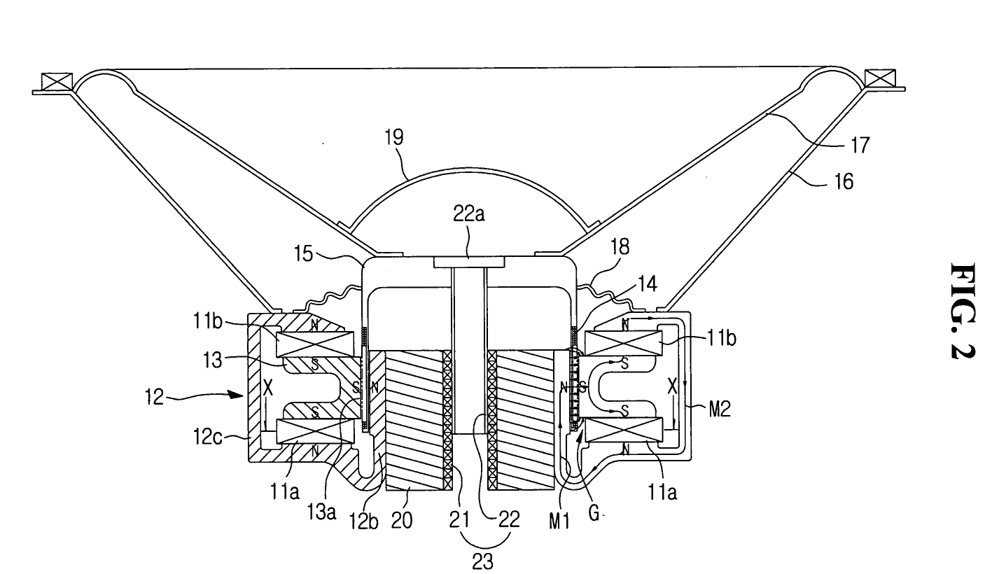

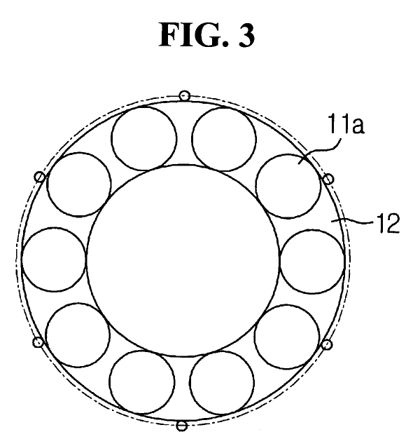

A cross-sectional view showing a high-efficiency, high output speaker having a dual magnet according to the present invention is shown in FIG. 2. A cross-sectional view cut along a line X-X of FIG. 2 is shown in FIG. 3.

Referring to FIGS. 2 and 3, a speaker having a dual magnet according to an embodiment of the present invention includes first and second magnetic circuits M1 and M2 which include a F-type(in which a magnet is located externally in a magnetic circuit) magnet 11a and a P-type(in which a magnet is located internally in a magnetic circuit) magnet 11b, respectively, to thereby realize uniform distribution of lines of magnetic force on opposing surfaces 12 and 13 of a yoke forming a magnetic gap G in a first magnetic circuit M1 including the F-type magnet 11a and prevent leakage of a magnetic flux in a magnetic gap portion by a loop-shaped second magnetic circuit M2 including the P-type magnet 11b, in which a bobbin 15 around which a voice coil 14 is wound is inserted into the magnetic gap G formed in the first magnetic circuit M1 in order to drive a vibrating diaphragm 17.

The F-type magnet 11a and the P-type magnet 11b which provide the magnetic forces for the first and second magnetic circuits M1 and M2, respectively use Neodymium (Nd) having a magnetic flux density more than eleven point five times as that of a ferrite magnetic material as shown in FIG. 3. Here, the Neodymium (Nd) magnetic material is formed into a disc-shaped divided pieces, and then strongly magnetized in a direct magnetization method.

Thus, since the present invention uses a perviously directly magnetized Neodymium (Nd) magnet having a strong magnetic force, an inexpensive direct magnetization facility can be used instead of an expansive magnetization facility of an indirect magnetization method, to thus reduce a facility investment cost. Also, a magnetization time can be shortened by using a direct magnetization method.

Also, when magnets are assembled, a number of divided pieces are fixed to yokes 12 and 13 by an adhesive. Accordingly, a problem of attracting other components due to a strong attraction force or a strong repulsive force in the case that magnets of identical polarities are assembled does not occur when the magnets are assembled into a single annular magnet.

Further, it is of course possible to use magnets in which an annular ferrite magnets or other magnetic materials are used and assembled as the magnets 11a and 11b, and then magnetized.

The first magnetic circuit M1 includes the F-type magnet 11a, an extension portion 12b which is extended upwards in the form of a pole piece at a certain distance from the inner circumference of the first yoke 12 which is disposed in the lower portion of the F-type magnet 11a, and the second yoke 13 which is disposed in the upper portion of the F-type magnet 11a, and forms a magnetic gap G between the opposing surface of the pole-piece shaped extension portion 12b and the second yoke 13. The second magnetic circuit M2 includes the second yoke 13, the P-type magnet 11b which is disposed in the upper surface of the second yoke 13 with an identical polarity (for example, an S pole), and a loop shaped circulation circuit portion 12c which is extended from the upper end of the P-type magnet 11b to the lower end of the F-type magnet 11a.

The loop shaped circulation circuit portion 12c forms the first yoke 12 integrally with the extension portion 12b. Also, the second yoke 13 is linearly branched off respectively to the upper surface of the first magnet 11a and the lower surface of the second magnet 11b from the opposing surface 13a forming the magnetic gap G, and is symmetrically extended, to thereby provide a path of lines of magnetic force.

As a result, since the first and second magnets 11a and 11b of identical dimensions and polarities are symmetrically disposed in the upper and lower portions of the second yoke 13 in the case of the first and second magnetic circuits M1 and M2, respectively, lines of magnetic force generated from the extension portion 12b in the first yoke 12 do not lean to any one side of the upper and lower portions of the second yoke 13, and are fed back to the first and second magnets 11a and 11b via the second yoke 13. Accordingly, uniform distribution of lines of magnetic force is realized on the opposing surfaces of the yokes 12 and 13, and a linear responsivity of a vibration system, that is, straightforwardness of a voice coil is improved, to thereby reduce a minute frequency distortion phenomenon.

Also, since the second yoke 13 forming an S pole is surrounded by the first yoke 12 forming an N pole and the first and second magnets 11a and 11b, a magnetic flux leakage phenomenon is suppressed and a driving force is reinforced with respect to a vibration system, to thereby increase a magnetic efficiency.

The bobbin 15 around which a voice coil 14 is wound is inserted into the magnetic gap G in the first magnetic circuit M1. The bobbin 15 is connected with the lower portion of the cone-shaped vibrating diaphragm 17. The upper portion of the vibrating diaphragm 17 is fixed to the upper portion of a frame 16. Also, a center cap 19 is coupled with the lower-center of the vibrating diaphragm 17. A damper 18 is connected with the lateral side of the bobbin 15 in order to limit a vibration width of the bobbin.

Meanwhile, a central portion of the pole piece type extension portion 12b in the first yoke 12 is empty. A heat radiation pipe 20 of an excellent heat conductivity, for example, an aluminium (Al) material is inserted into the central portion of the pole piece type extension portion 12b of the first yoke 12, in order to quickly discharge out heat generated from the voice coil 14, the magnets 11a and 11b, and the yoke 12, in an air cooling method.

The heat radiation pipe 20 plays a role of supporting a vertical guide 23 to be described later and minimizing a magnetic force applied from the extension portion 12b in the first yoke 12 forming an N pole to the inner vertical guide 23 and inducing lines of magnetic force to be concentrated toward the magnetic gap G, in addition to a heat radiation function.

The vertical guide 23 is provided in the central portion of the heat radiation pipe 20, which a cylindrical guide bearing 21 and a guide shaft 22 whose lower portion is inserted into the central portion of the guide bearing 21 and whose upper portion is supported by the upper portion of the bobbin 15 via a fixed plate 22a, to thereby vibrate precisely up and down movement of the bobbin 15.

Also, in the case that a speaker is fabricated into an ultra-sized sub-woofer of eighteen through twenty-four inches, the bobbin 15 is formed thick at a portion which is coupled with the fixed plate 22a in the guide shaft 22 and thin at a cylindrical portion around which the voice coil 14 is wound considering an interval of the magnetic gap G, for example, by an injection molding method. Also, a portion around which the coil 14 is wound can be formed as a recessed groove. In this case, the wound coil 14 is made of a quadruple layered structure so that an allowable input can be increased.

Also, the bobbin can be made of a metallic material such as aluminium or brass. In the case that the bobbin is fabricated in small size, it can be made of a film.

Further, in the case that a speaker is fabricated in small size, it is possible to omit the vertical guide 23.

Since the vertical guide 23 is provided in the present invention, the bobbin 15 is guided so that linear movement of the vertical direction is performed without left and right partial wear even in the case that a large input is applied to the coil 14 and thus the vibrating diaphragm 17 is greatly vibrated up and down.

In the present invention, the magnetic gap opposing surfaces 12a and 13a in the first and second yokes 12 and 13 are inserted into the magnetic gap G and are preferably lengthily formed to sufficiently cover a vibration range of the voice coil 14 so that a magnetic force is efficiently applied to the coil which vibrates up and down.

Hereinbelow, functions of a dual magnet speaker having the above-described structure will be described in detail.

In the present invention, size of magnets is increased by using dual magnets 11a and 11b. Divided piece type Neodymium (Nd) magnets which are magnetized in a direct magnetization method are used as F-type and P-type magnets 11a and 11b, to thereby form first and second magnetic circuits M1 and M2. Accordingly, a magnetic flux density in the magnetic gap G is increased, and an action force for the coil 14 is increased. Meanwhile, an opposing portion between the two yokes 12 and 13 forming the magnetic gap G is relatively lengthily extended in comparison with the conventional art, and a number of turns of the voice coil 14 which is inserted into the magnetic gap G is sufficiently increased to increase an allowable input. As a result, a speaker conversion efficiency, i.e., sound pressure level (SPL) is enhanced so that a vibration system can be sufficiently vibrated according to an input signal without any limitation.

Also, the present invention symmetrically forms the F-type magnet 11a and the P-type magnet 11b of an identical characteristic in the lower and upper portions of the second yoke 13 of a symmetrical structure, to thereby realize uniform distribution of lines of magnetic force on the yoke opposing surfaces 12a and 13a forming a magnetic gap and improve a linear responsivity, that is, straightforwardness of the voice coil, of a vibration system, and further add a loop type second magnetic circuit M2 to suppress magnetic flux leakage in the magnetic gap portion at minimum and to achieve high efficiency and low distortion frequency characteristics.

Meanwhile, a bass resonance frequency (f₀) is lowered as a mass of a vibration system is increased. In the present invention, a mass of a vibration system is increased, to thereby lower a bass resonance frequency (f₀) and improve a bass characteristic, in which the vibration system is formed by a coupling structure of the bobbin 15 which is formed thick at a portion where the fixed plate 22a is supported is added in the vibrating diaphragm 17 and the center cap 19, a quadruple layer voice coil 14, the vertical guide 23.

In the case that the present invention is applied to a sub-woofer speaker, a maximum rating power, that is, watts peak, can be realized up to ten thousand watts (10000 W).

Meanwhile, the vibrating diaphragm 17, the center cap 19, and the frame 16 are removed from the speaker structure and the upper surface of the bobbin 17 is greatly increased. Then, a plate-shaped vibrating diaphragm is attached on the upper portion of the bobbin 17 to thereby constitute a vibration generating device.

In this case, the vibration generating device is operates in the same driving principle as that of the speaker. That is, when a sinusoidal driving signal whose polarity is periodically varied is applied to the coil 14, the alternating rotating magnetic field of the driving coil 14 and the direct-current magnetic field in the magnetic gap G mutually act together, and the driving coil 14 wound around the bobbin 15 is vibrated up and down in the magnetic gap G. As a result, the vibrating diaphragm is also vibrated up and down.

Further, when at least three vertical guides and vibration absorption unit are added to the vibrating diaphragm in the outer portion of the vibration generating device, the vibrating diaphragm can perform linear movement in the vertical direction without left and right partial eccentricity when the vibrating diaphragm is vibrated up and down.

The vibration generating device is an aerobic exercise device without having a frictional and impact portion. Accordingly, the vibration generating device has a small amount of noise and wear of components such as partial wear, to thereby greatly heighten durability thereof.

Thus, the vibration generating device can be applied to industrial devices such as a physical treatment auxiliary device, a solid-liquid separator which separates solid from liquid, a classifier, a, grain washer in various forms according to addition of a coil driving circuit, as well as an aerobic exercise device.

Also, since the present invention uses a number of previously magnetized divided type magnets, the direct magnetization can be performed. Accordingly, a high efficiency of magnets can be obtained and an inexpensive magnetization facility can be used, in comparison with a conventional indirect magnetization method.

As described above, the present invention provides a magnetic circuit having a high efficiency, high output and low distortion frequency characteristics, and a speaker using the same, having an enhanced sound pressure level (SPL) of speaker in which size of the magnet is increased by a dual magnet, a magnetic flux density in a magnetic gap is increased by first and second magnetic circuits using a divided Neodymium (Nd) magnets, an opposing portion between two yokes forming a magnetic gap is relatively lengthily extended in comparison with the conventional art, and a number of turns of voice coil inserted into the magnetic gap is sufficiently increased in order to increase an allowance input, to thereby generate a sufficient vibration according to an input signal without limitation of a vibration system. The present invention provides a F-type magnet and a P-type magnet for first and second magnetic circuits, respectively, to thereby prevent leakage of magnetic flux.

Also, the present invention symmetrically forms a F-type magnet and a P-type magnet of an identical characteristic in the lower and upper portions of a second yoke of a symmetrical structure, to thereby realize uniform distribution of lines of magnetic force on the yoke opposing surfaces forming a magnetic gap and improve a linear responsivity of a vibration system, and further add a loop type second magnetic circuit to suppress magnetic flux leakage in the magnetic gap portion at minimum and to achieve high efficiency and low distortion frequency characteristics.

Further, the present invention increases a mass of a vibration system to thereby lower a bass resonance frequency (f₀). Also, the present invention provides a vertical guide for a bobbin to thereby guide the bobbin to perform linear movement of vertical direction without left and right partial wear even in the case that a large input is applied to a voice coil and a vibrating diaphragm is greatly vibrated up and down, and thus suppress a distortion phenomenon.

Also, the present invention provides an aerobic vertical exercise device or an industrial vibration generator whose noise and wear of components is small when a magnetic circuit according to the present invention is applied to a vibration generating device.

Therefore, the present invention provides a vibration generating device for a vertical exercise device providing a sufficient vertical movement force and having low noise and a small amount of wear of components, in which a vibrating diaphragm connected with a bobbin coil is driven up and down by a magnetic circuit using a dual magnet generating a strong magnetic force.

As described above, the present invention can be applied to a magnetic circuit and a speaker using the same. Also, the present invention can be applied to a vibration generating device which can be applied to industrial devices such as a physical treatment auxiliary device, a solid-liquid separator which separates solid from liquid, a classifier, a grain washer in various forms according to addition of a coil driving circuit, as well as an aerobic exercise device.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A speaker having a dual magnet comprising:
lower and upper magnets which are disposed at a predetermined distance so that mutually identical polarities oppose each other, for generating a non-alternating magnetic field;
a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet;
a second yoke which connects between the lower and upper magnets and whose inner circumferential surface forms a magnetic gap between the second yoke and the extension portion of the first yoke;
a coil which generates an alternating magnetic filed when an electrical driving signal is applied, and which is disposed in the magnetic gap and wound around a bobbin so as to be displaced up and down according to a mutual action with the non-alternating magnetic field;
a frame which is extended in a radial manner from the upper surface of the first yoke;
a vibrating diaphragm for generating an acoustic sound in correspondence to a drive signal when one end of the vibrating diaphragm is fixed to the bobbin and the other end thereof is fixed to the upper end of the frame and the coil is displaced up and down;
a damper for limiting a vibration range of the bobbin so that the bobbin vibrates within a predetermined vibration range; and
a center cap provided at the central portion of the vibrating diaphragm, while covering the bobbin.

2. The speaker having a dual magnet according to claim 1, wherein the lower magnet, the extension portion of the first yoke and the second yoke form a first magnetic circuit, and the lower magnet, the loop-shaped circulation circuit of the first yoke, the upper magnet and the second yoke form a second magnetic circuit.

3. The speaker having a dual magnet according to claim 1, wherein the second yoke forms a symmetrical structure and a structure of being branched off toward the lower surface of the upper magnet and the upper surface of the lower magnet from the inner circumferential surface forming the magnetic gap.

4. The speaker having a dual magnet according to claim 1, further comprising a vertical guide unit that guides the bobbin to perform vertical movement.

5. The speaker having a dual magnet according to claim 4, wherein the bobbin is formed of an inversed cup-shaped structure, and the vertical guide unit comprises a cylindrical guide bearing supported vertically in the inner-center of the extension portion of the first yoke; and a guide shaft whose upper side is supported with the upper-center of the bobbin and whose lower sider free end is inserted into the guide bearing.

6. The speaker having a dual magnet according to claim 5, further comprising a heat radiation unit which is inserted between the extension portion of the first yoke and the guide bearing, for discharging heat generated from the coil and the magnets.

7. The speaker having a dual magnet according to claim 1, wherein the lower and upper magnets are disposed so that N poles oppose each other, respectively, and are formed of a number of divided discs made of Neodymium (Nd).

8. The speaker having a dual magnet according to claim 1, wherein the lower and upper magnets have the same size so as to generate the same non-alternating magnetic field, so that the opposing surfaces between the outer circumferential surface of the extension portion of the first yoke and inner circumferential surface of the second yoke which form the magnetic gap have uniform distribution of lines of magnetic force in whole.

9. The speaker having a dual magnet according to claim 8, wherein the lower and upper magnets have the same size so as to generate the same non-alternating magnetic field, so that the opposing surfaces between the outer circumferential surface of the extension portion of the first yoke and inner circumferential surface of the second yoke which form the magnetic gap have uniform distribution of lines of magnetic force in whole.

10. A magnetic circuit having a dual magnet comprising:
lower and upper magnets which are disposed at a predetermined distance so that N poles oppose each other, for generating a non-alternating magnetic field;
a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet; and
a second yoke which connects between the lower and upper magnets and whose inner circumferential surface forms a magnetic gap between the second yoke and the extension portion of the first yoke,
wherein the opposing surfaces between the outer circumferential surface of the extension portion of the first yoke and the inner circumferential surface of the second yoke which form the magnetic gap have uniform distribution of lines of magnetic force in whole.

11. The magnetic circuit having a dual magnet according to claim 10, wherein the lower and upper magnets have the same size so as to generate the same non-alternating magnetic field.

12. A vibration generating device comprising:
lower and upper magnets which are disposed at a predetermined distance so that N poles oppose each other, for generating a non-alternating magnetic field;
a first yoke integrally having a loop-type circulating circuit portion extended from the lower surface of the lower magnet to the upper surface of the upper magnet and an extension portion which is extended perpendicularly upwards at a constant gap from the lower-inner circumferential surface of the lower magnet;
a second yoke which connects between the lower and upper magnets and whose inner circumferential surface forms a magnetic gap between the second yoke and the extension portion of the first yoke;
a driving coil which generates an alternating magnetic filed when an electrical driving signal is applied, and which is disposed in the magnetic gap and wound around a bobbin so as to be displaced up and down according to a mutual action with the non-alternating magnetic field;
a cylindrical bobbin in which the driving coil is wound around a cylindrical body;
a vibrating diaphragm which is coupled with the upper end of the bobbin, performing an up-and-down vibration; and
a vertical guide unit for guiding the bobbin to perform vertical movement when the vibrating diaphragm is vibrated up and down.

13. The vibration generating device according to claim 12, wherein the vertical guide unit comprises a cylindrical guide bearing supported vertically in the inner-center of the extension portion of the first yoke; and a guide shaft whose upper side is supported with the upper-center of the bobbin and whose lower sider free end is inserted into the guide bearing.

14. The vibration generating device according to claim 12, wherein the lower and upper magnets are disposed so that N poles oppose each other, and made of a number of divided type discs of Neodymium (Nd).

15. The vibration generating device according to claim 12, wherein the lower and upper magnets have the same size so as to generate the same non-alternating magnetic field, so that the opposing surfaces between the outer circumferential surface of the extension portion of the first yoke and inner circumferential surface of the second yoke which form the magnetic gap have uniform distribution of lines of magnetic force in whole.
